(19) United States
(12) Patent Application Publication
(10) Pub. No.: US 2007/0143701 A1
(43) Pub. Date: Jun. 21, 2007

(54) Tab control

(76) Inventors: Stephen Iremonger, Mountain View, CA (US); David Clark, Morgan Hill, CA (US); Donald Geoffrey Schuller, San Jose, CA (US); Christopher Crim, San Jose, CA (US)

Correspondence Address: FISH & RICHARDSON P.C., PO BOX 1022, MINNEAPOLIS, MN, 55440-1022, US

(21) Appl. No.: 11/305,564

(22) Filed: Dec. 16, 2005

(51) Int. Cl. G06F 17/00

(52) U.S. Cl. 715/777

(57) ABSTRACT

A tab control includes a tab and a tab region including the tab. The tab region is capable of displaying one or more objects when the tab is activated.

### TECHNICAL FIELD

The disclosed implementations relate to graphical user interfaces.

### BACKGROUND

A database is a collection of information with a defined structure, such as a telephone directory or library catalogue. A database application that handles, organizes, and sorts database information is commonly referred to as a Database Management System (DBMS). A DBMS enables users to perform data management tasks, such as creating and editing databases.

One popular database application is FileMaker Pro®, developed by FileMaker® (Santa Clara, Calif.). FileMaker Pro® is a type of DBMS that includes a database engine that is integrated with forms or layouts used to access and modify the database. Users can build custom interfaces by dragging objects (e.g., tab controls, text fields, images, control buttons, etc.) from a tool panel into a layout.

FIG. 1 illustrates the basic structure of a conventional tab control 100. The tab control 100 includes tab panels 102. Generally, the tab panel 102 is the area displayed when a tab 106 associated with the tab panel 102 is selected by a user (e.g., by a mouse click). Users can organize objects 104 (e.g., lines, fields, buttons, portals, imported graphics, blocks of text, etc.) within the borders of the tab panel 102. A row (or column) of tabs are collectively referred to as a tab strip 108.

One purpose of the tab control 100 is to show only the tab panel 102 associated with the selected tab 106. For example, if a user clicks on the tab 106, the “Classes” tab panel 102, including its associated objects 104 (e.g., text fields), is displayed. The “Student” and “Grades” tab panels are hidden behind the “Classes” tab panel 102, except for their respective tabs which remain visible in the tab strip 108. Thus, the tab control 100 simplifies entering and viewing data by allowing a user to group related objects on different tab panels in the same layout.

In conventional applications and development environments, a designer is only able to place objects in the tab panel 102. The portion 110 of the tab control 100 that is used to display the tab strip 108 is typically left blank and cannot be used to display objects. Given the limited space available for customizing a layout, such wasted space in the tab control may be undesirable to many users.

### SUMMARY

A tab control includes a tab and a tab region including the tab. The tab region is capable of displaying one or more objects when the tab is activated. The disclosed improved tab control provides one or more advantages over conventional tab controls, including but not limited to providing user interface designers more flexibility over the appearance of a tab control and how it presents information in a layout.

### DESCRIPTION OF DRAWINGS

FIG. 1 illustrates a conventional tab control.

FIG. 2 illustrates an improved tab control.

FIGS. 3A and 3B illustrate the placement of objects in a tab region of an improved tab control.

FIG. 4 illustrates the use of a tab control tool to create an improved tab control.

FIG. 5 is a system architecture for creating, displaying and using an improved tab control.

### DETAILED DESCRIPTION

### Improved Tab Control

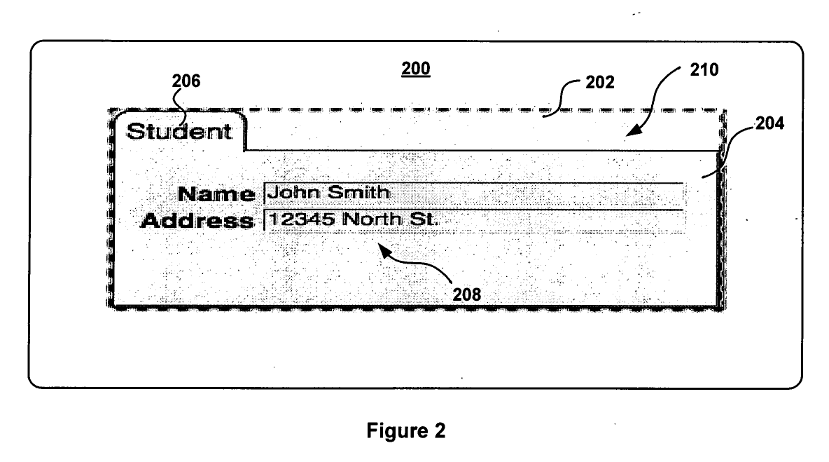

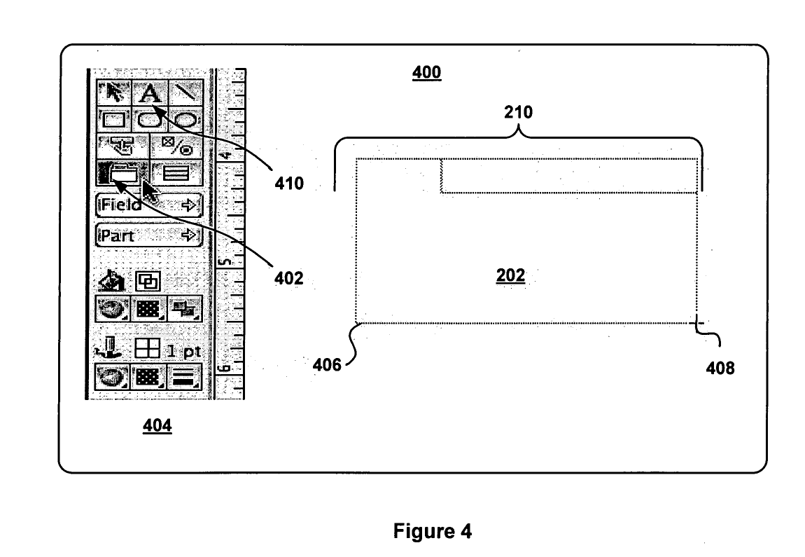

FIG. 2 illustrates an improved tab control 200. In some implementations, the improved tab control 200 includes an active region 202. The size of the active region 202 is determine when the tab control 200 is first drawn in the layout, as described with respect to FIG. 4. Within the active region 202 is a tab panel 204, a tab 206 and a tab region 210 which includes the tab 206. The tab panel 204 can include one or more objects 208. An “object” as used herein is a discrete entity or shape that a user or a system (e.g., a DBMS) can select, move, modify and delete, including but not limited to: lines, fields, buttons, portals, graphics, blocks of text, tab controls and the like.

Conceptually, one might think of the tab control 200 as an electronic rolodex, or a stack of tab cards, like libraries use to catalog their books. When a different card (tab) is brought to the front of the stack, one then sees the contents of that card (tab panel).

The active region 202 represents the boundaries of the displayable and/or active portion of the tab control 200. Any objects within the boundaries of the active region 202 will be displayed and/or made active when the tab panel 204 is activated (e.g., selected by a user). This includes any object placed in the tab region 210. Thus, the displayable and/or active portion of the tab control 200 is the entire active region 202, including the tab region 210, and not just the tab 206 and tab panel 204, as is typically displayed in conventional tab controls.

In some implementations, whether or not a particular object in a layout will be displayed in the tab panel 204 is determined by a set of stacking order rules. For example, if the tab control 200 is moved or dragged over another object in the layout that is below the tab control 200 in a stacking order, the object will not become part of the tab control 200. If the object is above the tab control 200 in the stacking order, then it will become part of the tab control 200, provided the object is entirely enclosed by the tab control 200. It should be apparent that more or fewer rules can be used to determine whether a particular object in a layout belongs to a particular active region 202.

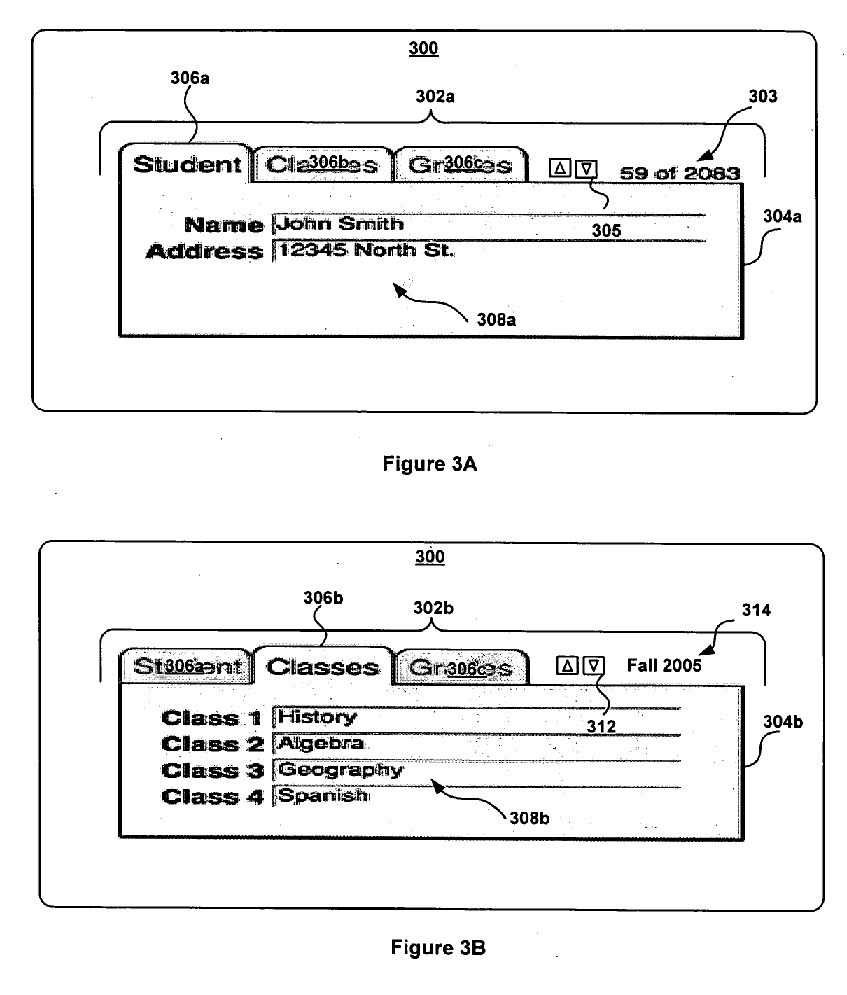

Although FIG. 2 shows a single active region 202 with a single tab panel 204, the improved tab control 200 can include multiple tab panels, each of which includes its own active region, and therefore its own tab and tab region. The tab regions for each active region can contain different numbers and types of objects which are displayed and/or activated only when the corresponding tab panel is activated, as described with respect to FIGS. 3A and 3B.

### Tab Regions

FIG. 3A illustrates the placement of objects 303 and 305 in the tab region 302a of an improved tab control 300. In this implementation, the tab control 300 is used to organize and display the classes and grades of a number of students for a learning institution. When the user clicks on tab 306a, the active region associated with tab 306a is displayed and/or made active, including the tab region 302a and any objects contained in the tab region 302a. For example, if the user selects tab 306a (the “Student” tab), the tab panel 304a is moved to the front and a text object 308a containing name and address fields is displayed. The user can then enter information into these fields. The other two tab panels associated with “Classes” and “Grades” (including any objects contained in those tab panels) are hidden from the user.

Displayed in the tab region 302a (next to the “Grades” tab) is an object 303. In this example, the object 303 is a text object for displaying the number of the student whose name and address are displayed in the tab panel 304a (i.e., “59 of 2083”). In some implementations, the tab region 302a can also include one or more interactive objects 305, such as, for example, buttons for scrolling forward and backward through student records. In this example, the objects 303, 305 are only displayed when the tab region 302a is activated (e.g., the tab 306a is clicked by a user). Any objects in the tab regions associated with tabs 306b, 306c are hidden from the user and/or deactivated. Thus, the tab regions associated with each tab 306a, 306b and 306c, can include different numbers and types of objects.

It should be apparent that a designer can place one or more objects anywhere in the tab region 302a and the objects become part of the content that is displayed when the tab 306a is activated. For example, in FIG. 3A any objects (e.g., objects 305 or 303) added to the tab region 302a would become part of the tab control 300.

Referring to FIG. 3B, if the user selects tab 306b (the “Classes” tab), the tab panel 304b is moved to the front and a text object 308b containing class fields is displayed. The user can enter information into these fields. Displayed in the tab region 302b (next to the “Grades” tab) is an object 312 (e.g., buttons). The user can click the buttons 312 to change the data displayed in the text object 308b. For example, the user can click the button to see the classes taken by student #59 during the Fall and Spring semesters of a particular year. Also included in the tab region 302b is a text object 314 for indicating when the classes were taken (i.e., “Fall 2005”).

An important advantage of the improved tab control 300 is that the tab regions 302a and 302b can be used to augment the tab control 300 with one or more objects that can be selectively activated and/or displayed to provide the user with additional functionality and/or flexibility in organizing and displaying data.

### Creating Improved Tab Controls

FIG. 4 illustrates the use of a tab control tool 402 to create an improved tab control in a layout 400. In some implementations, the tab control tool 402 is displayed in a tool panel 404. Clicking on the tab control tool 402 causes a crosshair 408 to be displayed in the layout. The user can then drag the crosshair to draw an outline 406 of a tab control. The outline 406 encloses an active region 202 for the tab control, including a tab region 210.

In some implementations, when the tab control is drawn a dialogue user interface (UI) is automatically displayed which enables a user to select various attributes for the tab control, including but not limited to the number, location (e.g., vertical, horizontal, etc.) and appearance of tabs (e.g., color, transparency, font, alignment, pen thickness, style, the shape of the tabs, the placement an size of the tabs, etc.). Once the attributes are selected the tab control can be rendered in the layout 400. If the user wants to re-edit the tab control, then the user can invoke the dialogue UI by selecting the appropriate button in the tool panel 404, or selecting an edit option from a menu or other user interface element.

The user can create and place different numbers and types of objects (or drag existing objects) into the tab panels of the tab control and the tab region 210. For example, a text tool 410 can be selected from the tool panel 404 and used to create a text object in the layout 400. The text object can then be dragged to the tab region 210.

### System Architecture

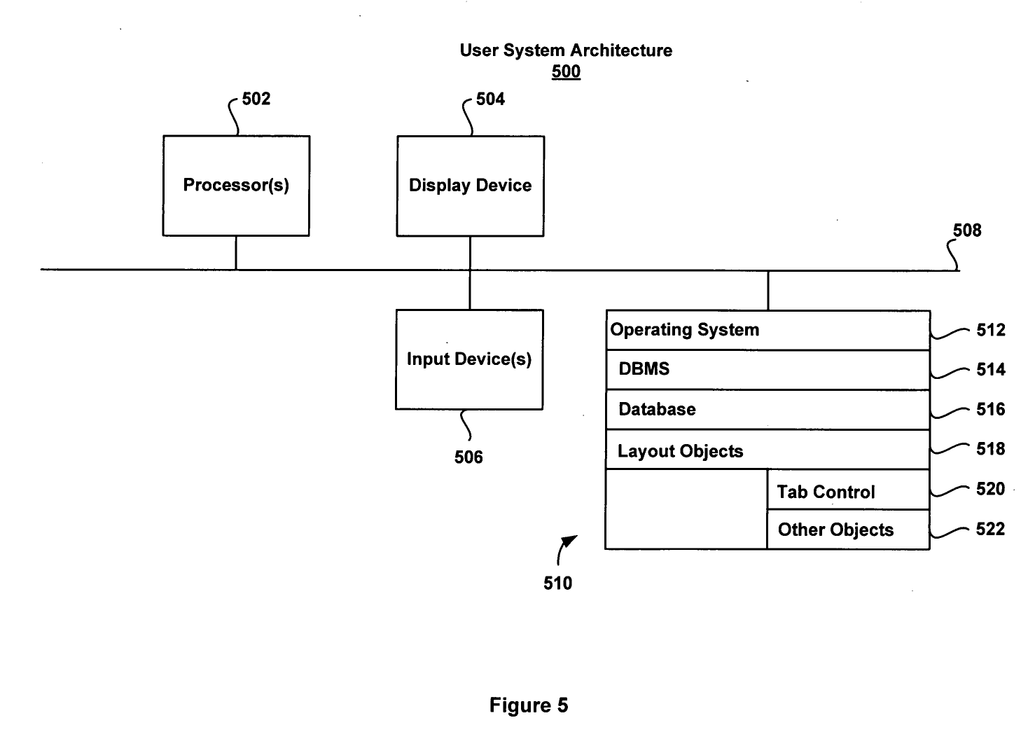

FIG. 5 is a system architecture 500 for creating, displaying and using an improved tab control. In some implementations, the architecture 500 includes one or more processors 502 (e.g., a CPU), a display device 504 (e.g., CRT, LCD), input devices 506 (e.g., keyboard, mouse, etc.), and one or more computer-readable mediums 510. These components exchange communications and data via one or more buses 508 (e.g., EISA, PCI, USB, FireWire™, NUBUs™, PDS, etc.).

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 510 further includes an operating system 512 (e.g., Mac OS®, Windows®, Linux, etc.), a DBMS 514, a database 516 and layout objects 518. Layout objects 518 include but are not limited to tab control 520 and other objects 522 (e.g., text objects, etc.).

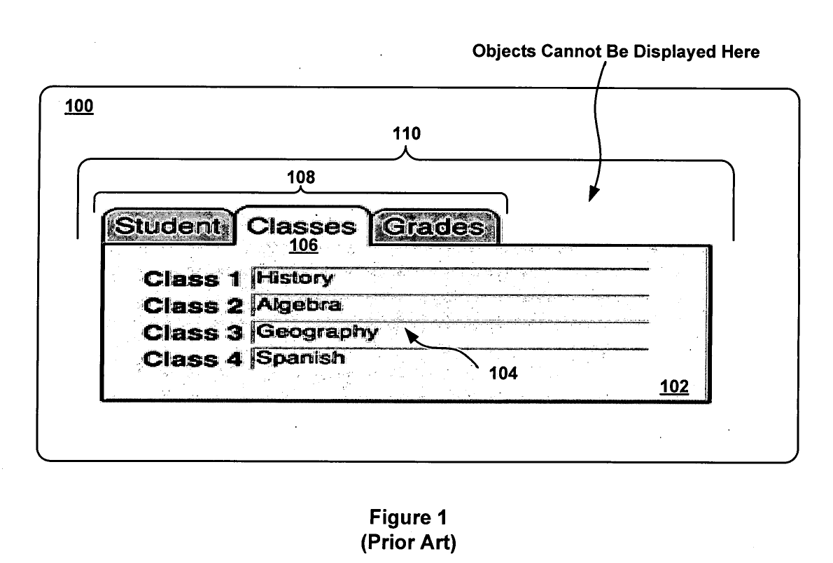

The operating system 512 can be multi-user, multiprocessing, multitasking, multithreading, real-time and the like. The operating system 512 performs basic tasks, including but not limited to: recognizing input from input devices 508; sending output to the display device 504; keeping track of files and directories on computer-readable mediums 510 (e.g., memory or a storage device); controlling peripheral devices (e.g., disk drives, printers, etc.); and managing traffic on the one or more buses 508. The DBMS 514 provides the development environment for creating custom layouts using improved tab controls 520, as described with respect to FIGS. 1-4. The database 518 stores the data that is organized and displayed by the improved tab control 520.

Various modifications can be made to the disclosed implementations and still be within the scope of the following claims.

What is claimed is:

1. A tab control, comprising:
a tab; and
a tab region including the tab, the tab region capable of displaying one or more objects when the tab is activated.

2. The tab control of claim 1, wherein at least one object is a graphical image.

3. The tab control of claim 1, wherein at least one object is a user interface element, which becomes active if the tab is activated.

4. The tab control of claim 1, wherein at least one object is text.

5. The tab control of claim 1, wherein the tab control is associated with a set of stacking order rules for determining if one or more objects in a layout are associated with the tab control.

6. A tab control, comprising:
an active region including a tab and a tab region, wherein the tab region displays one or more objects or data when the tab is activated.

7. A tab control, comprising:
a first tab and a first tab region including the first tab and a first object; and
a second tab and a second tab region including the second tab and a second object, wherein when the first tab is activated the first tab region displays the first object and the second object is not displayed, and wherein when the second tab is activated the second tab region displays the second object and the first object is not displayed.

8. A tab control method, comprising:
displaying a tab control having a plurality of tab regions, wherein each tab region includes a tab, the tab region adapted for displaying one or more objects or data;
receiving a first input selecting a first tab;
in response to the first input, displaying a first tab region associated with the first tab, including displaying one or more objects or data associated with the first tab region;
receiving a second input selecting a second tab; and
in response to the second input, displaying a second tab region associated with the second tab, including displaying one or more objects or data associated with the second tab region.

9. The method of claim 8, further comprising:
receiving a third input associated with an object or data associated with the first tab region; and
in response to receiving the third input, performing an action on the object or data associated with the first tab region.

10. A computer-readable medium having stored thereon instructions, which, when executed by a processor, causes the processor to perform the operations of:
displaying a tab control having a plurality of tab regions, wherein each tab region includes a tab, the tab region adapted for displaying one or more objects or data;
receiving a first input selecting a first tab;
in response to the first input, displaying a first tab region associated with the first tab, including displaying one or more objects or data associated with the first tab region;
receiving a second input selecting a second tab; and
in response to the second input, displaying a second tab region associated with the second tab, including displaying one or more objects or data associated with the second tab region.

11. The computer-readable medium of 10, further comprising:
receiving a third input associated with an object or data associated with the first tab region; and
in response to receiving the third input, performing an action on the object or data associated with the first tab region.

12. A method of creating a tab control, comprising:
drawing an active region for the tab control in a layout, wherein the active region includes a tab region containing a tab;
creating an object; and
placing the object in the tab region.

13. The method of claim 12, wherein placing the object in the tab region includes dragging the object from a first location in the layout to a second location in the tab region.

14. A computer-readable medium having stored thereon instructions, which, when executed by a processor, causes the processor to perform the operations of:
drawing an active region for the tab control in a layout, wherein the active region includes a tab region containing a tab;
creating an object; and
placing the object in the tab region.

15. The computer-readable medium of claim 14, wherein placing the object in the tab region includes dragging the object from a first location in the layout to a second location in the tab region.

16. The computer-readable medium of claim 14, wherein the object is a graphical image.

17. The computer-readable medium of claim 14, wherein the object is a user interface element, which becomes active if the tab is activated.

18. A tab control system, comprising:
a processor;
a computer-readable medium operatively coupled to the processor and having instructions stored thereon, which, which when executed by the processor causes the process to perform the operations of:
displaying a tab control having a tab and a tab region including the tab;
receiving an input selecting the tab; and
in response to the input, displaying the tab region, including displaying one or more objects or data in the tab region.

19. The system of claim 18, wherein at least one object is a graphical image.

20. The system of claim 18, wherein at least one object is a user interface element, which becomes active if the tab is activated.
